(19) United States
(12) Patent Application Publication
(10) Pub. No.: US 2006/0186338 A1
(43) Pub. Date: Aug. 24, 2006

(54) Method for improving measurement accuracy of infrared imaging radiometers

(76) Inventors: Gerard DiTaranto, Parsippany, NJ (US); James LaGrotta, Boonton Twp., NJ (US); Frank Vallese, Montville, NJ (US)

Correspondence Address: HOFFMAN, WASSON & GITLER, P.C., Suite 522, 2461 South Clark Street, Arlington, VA, 22202, US

(21) Appl. No.: 11/325,431

(22) Filed: Jan. 5, 2006

Related U.S. Application Data
(63) Continuation-in-part of application No. 11/071,477, filed on Mar. 4, 2005, now abandoned.
(60) Provisional application No. 60/549,917, filed on Mar. 5, 2004.

(51) Int. Cl. G01J 5/02

(52) U.S. Cl. 250/338.1

(57) ABSTRACT

The present invention is directed to a method for improving measurement accuracy of infrared imaging radiometers utilizing a small pitch infrared detector array. The detector offset is changed so that the detector output, when observing a particular object temperature, is maintained at a desired level over a range of ambient temperatures.

### CROSS-REFERENCED APPLICATIONS

The present application claims the priority of provisional patent application Ser. No. 60/549,917, filed Mar. 5, 2004, as well as utility patent application Ser. No. 11/071,477, filed Mar. 4, 2005.

### FIELD OF THE INVENTION

The present invention is directed to the field of infrared imaging and radiometric cameras.

### BACKGROUND OF THE INVENTION

In an effort to lower the cost of infrared imaging radiometers, small pitch and non-temperature-stabilized detector arrays have recently been incorporated in calibrated systems. For example, pervious detector arrays generally would utilize infrared detector arrays having pixels at a 50-micron pitch. These detector arrays would generally include thermoelectric (TE) coolers having a fixed temperature set point. The recently developed small pitch and non-temperature-stabilized detector arrays would typically utilize arrays having a pixel pitch 40 microns or smaller. These smaller arrays would not include detector temperature stabilization. The reduction in the size of the array results in smaller, less expensive optics and lower overall manufacturing costs. The removal of the TE cooler would also further reduce costs. As a consequence, infrared imaging radiometers can be produced at a smaller and lower cost than those radiometers previously available.

The use of smaller pitch detector arrays can significantly impact the system modulation transfer function (MTF). This results in radiometric measurements that are inappropriately dependent on the apparent image size of the object or the distance between the object and the observer. In addition, the output images will have reduced contrast and a reduced ability to discern small objects. Infrared imaging radiometers in particular in which the object temperature is calculated by measuring the object's apparent blackbody radiation, would result in an object size dependent to the temperature calculation of that object. As a consequence, in order to produce accurate quantitative radiance measurements for these lower resolution array radiometric cameras that are independent of the image size, a substantial minimum image size would then be required. As an example, for a radiometric infrared camera, to maintain the same uncorrected accuracy, a camera based on a 25-micron pitch detector would need images of objects on the display having four times as many pixels as a camera based on a 50-micron pitch detector. Additionally, the removal of the TE cooler would result in a variation of the base line response of the unit and consequently adversely impact radiometric accuracy and the camera's object temperature dynamic range over a variety of ambient temperatures.

### SUMMARY OF THE INVENTION

The deficiencies of the prior art are overcome utilizing the present invention, which is directed to a method for improving the qualitative and quantitative measurement performance of infrared imaging and radiometric cameras. Traditional methods of determining the measurement performance of these cameras have inaccuracies due to the effects of changes in ambient temperature, as well as the size of the objects.

The method of the present invention would use a specific deconvolution technique designed to maintain radiometric accuracy as well as to correct for the object size due to detector objective lens MTF.

### BRIEF DESCRIPTION OF THE DRAWINGS

FIG. 1 is a block diagram of a prior art system; and

FIG. 2 is a block diagram of the approach of the present invention.

### DETAILED DESCRIPTION OF THE PRESENT INVENTION

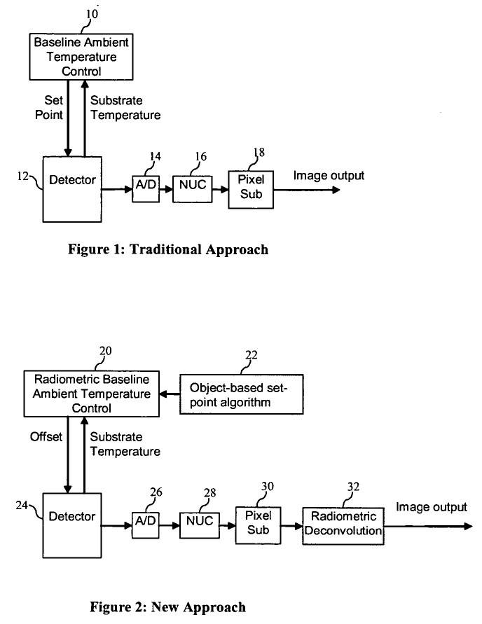

FIG. 1 describes a traditional method of processing information produced by an infrared detector 12. This method incorporated a baseline ambient temperature control 10 employing a fixed temperature set-point. The temperature of the detector array would be transmitted from the detector 12 to the baseline ambient temperature control 10 to the detector 12. However, this approach does not factor in the situation in which a given object temperature varies with the detector temperature. Information produced by the detector 12 is an analog form which would be converted into digital information utilizing an A/D converter 14. This information would then be transmitted to a non-uniformity correction (NUC) 16 as well as a pixel substitution signal 18 thereby producing an image output. The NUC is used to compensate for detector cell variation in gain or level across the entire detector array.

The method according to the present invention specifically changes the detector offset as shown in FIG. 2 so that the detector output, when observing a certain temperature object, is constant over a range of ambient temperatures. A unique radiometric baseline ambient temperature control 20 utilizes an object-based set-point algorithm 22 to produce the offset which is transmitted from the radiometric baseline temperature control 20 to the detector 24. The object-based set-point algorithm, along with the radiometric baseline ambient temperature control, would also utilize the detector temperature which would be obtained from the detector subsystem 24, for example, to the radiometric baseline ambient temperature control 20. The detector offset value is changed based upon the temperature and the results of a pre-calibration method for determining the proper set-point. It is noted that this method differs from the traditional approach in which the set-point remains unchanged. The result is a camera dynamic range as defined by the observable object temperature range would be constant over a wide variation in ambient operating temperature.

In order to correct for errors associated with the object's size, a real-time radiometric deconvolution is performed based upon the information received from an A/D converter 26 for converting the analog information produced by the detector 24 into a digital signal. This digital signal is transmitted to a NUC 28 as well as the pixel substituted signal 30 to produce an image output after the radiometric deconvolution is utilized.

The radiometric deconvolution is performed on the non-uniformity-corrected pixel substituted signal. Unlike traditional deconvolution methods, the present invention employs an energy-conversing approach that is specifically designed to maintain radiometric accuracy as well as to correct for the optic size variations due to the texture and objective lens MTF. To implement this method, the camera's optical system is modeled using an observed image g(x,y) and can be estimated as the convolution of the true image f(x,y), as well as the modulation transfer function (MTF), h(x,y) contaminated by noise and n(x,y) that can occur from various sources. The system MTF is normally a combination of the MTF due to the objective lens as well as the detector. Several well-known linear image restoration techniques exist to determine the corrected image based on the PSF and distorted image, including inverse filtering, Wiener filtering, least-squares filtering, recursive Kalman filtering and constrained iterative deconvolution methods.

Various embodiments of the invention have been described. The description is intended to be illustrative, and not limited. Thus, it would be apparent to one skilled in the art that certain modifications may be made to the invention as described without departing from the scope of the claims set out below.

What is claimed is:

1. A method for improving the measurement accuracy of infrared imaging radiometers, comprising the steps of:
receiving an observed image in an infrared detector array;
estimating the convolution of the true image; and
radiometrically deconvolving said true image utilizing a modulation transfer function.

2. A method for improving the measurement performance and dynamic range of infrared imaging radiometers including the steps of:
initially producing a detector offset value;
changing said detector offset value based upon the temperature of said detector subsystem.

3. The method in accordance with claim 2, further including the step of determining a proper set-point utilizing a pre-calibration algorithm.

4. The method in accordance with claim 1, in which said detector is an array containing a pixel pitch smaller than 40-micron.

5. The method in accordance with claim 2, in which said detector is a non-temperature-stabilized array.

6. The method in accordance with claim 3, in which said detector is a non-temperature-stabilized array.
